(19) United States
(12) Patent Application Publication
(10) Pub. No.: US 2019/0062172 A1
(43) Pub. Date: Feb. 28, 2019

(54) PROCESS FOR REMOVAL OR RECOVERY OF AMMONIUM NITROGEN FROM WASTEWATER STREAMS

(71) Applicant: Boost Environmental systems Inc., Vancouver (CA)

(72) Inventors: Donald S. Mavinic, North Vancouver (CA); Sergey Lobanov, Vancouver (CA); Frederic A. Koch, Vancouver (CA); Sharmeen Farhana, Vancouver (CA)

(73) Assignee: Boost Environmental systems Inc., Vancouver (CA)

(21) Appl. No.: 15/690,809

(22) Filed: Aug. 30, 2017

(51) Int. Cl. C01C 1/02; C02F 1/38; C02F 1/00; C05C 3/00; C04B 18/04

(52) U.S. Cl. CPC C01C 1/026; C02F 1/38; C02F 1/001; C02F 2101/105; C04B 18/04; C02F 2001/007; C05C 3/00

(57) ABSTRACT

It is provided process of extracting ammonia gas from a source containing magnesium ammonium phosphate (MAP) particles such as wastewater comprising the steps of isolating MAP particles from the wastewater, heating the MAP particles to a temperature of 50-120° C. in an atmosphere with a relative humidity between 50-120%, decomposing the MAP and producing a solid comprising magnesium hydrogen phosphate and ammonia gas; and collecting the ammonia gas. The MAP particles are MgNH₄PO₄.6H₂O or struvite.

### TECHNICAL FIELD

It is provided a process of extracting ammonium from magnesium ammonium phosphate particles by heating magnesium ammonium phosphate particles to a temperature of 50-120° C. in an atmosphere with a relative humidity of between 50 and 120%.

### BACKGROUND

Ammonium ions wastewater pollution represents a serious environmental problem. Ammonia release from wastewater treatment plants has increased significantly in recent years and is responsible for the eutrophication of aquatic systems which occur due to the enhanced discharge of excess nitrogen and phosphorus, leading to death of aquatic organisms and enhanced algal blooms. The formation of extreme algal growth leads to the death of aquatic aerobic organisms and thus causes oxygen-deficient zones in water bodies.

Ammonia is used in the agricultural industry as a source of nitrogenous fertilizer for crop production. Ammonia is commonly supplemented in the animal husbandry sector to the feed in order to increase its nutrient value and to promote the growth of animals. Ammonia is also used in other sectors such as mining, pulp industry, paper industry, food processing, and refining.

Therefore, sustainable ammonia production is an important economical need. Since wastewater effluent, containing high ammonia can cause eutrophication, and considering the abundance of ammonia in wastewater, removal and recuperation of ammonia from wastewater represent not only a sustainable source for ammonia production, but also an opportunity to environmentally reduce wastewater pollution.

Nitrogen is one of the most essential nutrients for all forms of life including plants and organisms. In order to meet the nutritional needs for plants and organisms, nitrogen needs to be fixed, as normally accomplished through the production of synthetic ammonia using the Haber-Bosch process:

N₂(g)+3H₂(g)→2NH₃(g) ΔH=−92 kJ/mol.

Ammonia is synthesized from nitrogen and hydrogen at temperatures of 400-450° C. and pressures of 10-30 MPa in the presence of an iron catalyst.

Various methods for ammonium ion removal from wastewater have been extensively studied. Generally, wastewater treatment plants use biological nutrient removal processes to satisfy the nitrogen discharge guidelines in aquatic systems. However, ammonia is destroyed during this process and converted to nitrogen, while nitrogen is converted back into ammonia through Haber-Bosch process at high temperature and pressure.

Alternatively, known ammonia recovery methods are used that require extensive resources and energy consumption.

Ammonia recovery through what is known as the “air stripping method” requires the temperature of water to be increased from over 60° C. to between 90-100° C. by preheating and pH to be maintained at 10.5 since the solubility of ammonia decreases as the temperature and pH increases. The ammonium ion transforms into ammonia gas which is subsequently captured and transformed into synthetic fertilizer. Normally, compressed air is forced through the wastewater in a stripping column to increase the mass transfer of ammonia into the atmosphere. This process is usually performed at high pH values by addition of significant amount of caustic. The addition of caustic can cause scaling of stripping towers and other material, requiring frequent descaling. Furthermore, the addition of steam and air, conveyance and heating of huge amounts of wastewater results in substantial operational and maintenance costs.

Another way of recovering ammonia is by using the “membrane method” which essentially consists in a hydrophobic hollow fiber membrane which separates the waste solution phase from the acid absorption phase, to provide an ammonia concentration gradient between the two phases. At high pH, dissolved ammonium ion (NH₄⁺) converts into free ammonia gas which transfers through the hollow fiber membrane from the waste solution to the acid solution. Ammonia gas subsequently reacts with acid to form an ammonium salt which maintains the concentration gradient for continuous transfer of ammonia gas through the membrane. The operating costs for this process are still very high.

The “ion exchange method” is another alternative for ammonia removal from wastewater wherein for example a zeolite resin, especially clinoptilolite, is used. Essentially, the ion exchange resin adsorbs aqueous ammonia from wastewater, which is regenerated using a solution containing zinc and sulfuric acid. The external addition of acid causes crystallization of ammonium zinc sulfate hexahydrate ((NH₄)₂SO₄ZnSO₄.6H₂O). The ammonium zinc sulfate hexahydrate is afterward decomposed to release ammonia and sulfur trioxide. The ammonia gas released is captured in the sulfuric acid and then is used to produce commercial ammonium sulfate fertilizer. This process is also an expensive methodology since it uses a complex design, heavy chemical and heating requirements.

It is thus still desirable to be provided with a mean to recover ammonia from wastewater which would allow controlling effluent ammonia concentration and producing a commercial resource.

### SUMMARY

In accordance with the present disclosure, it is provided a process of extracting ammonia gas from a source containing magnesium ammonium phosphate (MAP) particles comprising the steps of isolating MAP particles from the source; heating MAP particles to a temperature of 50-120° C. in an atmosphere with a relative humidity between 50-120%, decomposing the MAP and producing a solid comprising magnesium hydrogen phosphate and ammonia gas; and collecting the ammonia gas.

In an embodiment, the MAP particles are MgNH₄PO₄.6H₂O.

In another embodiment, the source of MAP particles is heated a temperature of 75-85° C.

In a further embodiment, the relative humidity is between 80-100%.

In an additional embodiment, the MAP particles are heated and decomposed for up to 24 hours.

In an embodiment, the MAP particles are heated and decomposed for 1-2 hours.

In another embodiment, the source of MAP particles is wastewater.

In a further embodiment, the wastewater is municipal wastewater, industrial wastewater or agriculture wastewater.

In an additional embodiment, the process described herein further comprises the steps of mixing the solid comprising magnesium hydrogen phosphate with the source of MAP particles; isolating the MAP particles; heating the MAP particles mixed with to the solid decomposing the MAP and producing a new solid comprising magnesium hydrogen phosphate and ammonia gas; and collecting the ammonia gas.

In an embodiment, at least one of magnesium ions and orthophosphate ions are added to the source of MAP particles.

In a further embodiment, the MAP particles are isolated by settling, sedimentation, filtration or fluidization.

In another embodiment, the MAP particles are isolated by vacuum/pressure filtration, separation in hydrocyclones or centrifugal separation.

In an embodiment, the collected ammonia gas is further processed as a fertilizer.

In another embodiment, the MAP particles are heated and decomposed in a solid-gas process unit.

In a further embodiment, the solid-gas process unit is a fluidized bed or a drum dryer.

In an additional embodiment, humid hot air or gas is used to maintain the temperature and relative humidity.

In an embodiment, the humid hot air or gas is created by mixing dry air or gas with steam.

In a supplemental embodiment, the humid hot air or gas is created by dispersing liquid water in hot air or gas.

In an embodiment, the process is performed in a batch mode, semi-batch mode or in a continuous mode.

In another embodiment, the collected ammonia gas is captured by absorption or adsorption.

It is further provided a process of extracting ammonia gas from a source containing magnesium ammonium phosphate (MAP) particles and extracting potassium ions from a source containing them comprising the steps of isolating MAP particles from the source; heating MAP particles to a temperature of 50-120° C. in an atmosphere with a relative humidity between 50-120%, decomposing the MAP and producing a solid comprising magnesium hydrogen phosphate and ammonia gas; collecting the ammonia gas; mixing the solid comprising magnesium hydrogen phosphate with a source containing potassium ions or a mix of ammonium and potassium ions and producing a new solid comprising magnesium potassium phosphate (MKP) or a mix of MKP and MAP; and isolating the MKP or a mix MKP and MAP particles from the source.

In an embodiment, the magnesium hydrogen phosphate is further incorporated into cement.

It is also provided in accordance to one embodiment a cement material comprising magnesium hydrogen phosphate produced by the process described herein.

### BRIEF DESCRIPTION OF THE DRAWINGS

Reference will now be made to the accompanying drawings.

FIG. 1 illustrates a schematic representation of the process described herein in accordance with an embodiment.

FIG. 2 illustrates kinetic curves showing the percent mass loss of struvite over time at different heating temperature.

FIG. 3 illustrates the N—NH₄ molar ratio with respect to Mg(PO₄) over time at different heating temperatures.

FIG. 4 illustrates the H₂O molar ratio with respect to Mg(PO₄) over time at different heating temperatures.

FIG. 5 illustrates the N—NH₄ molar ratio with respect to Mg(PO₄) after 7 hours duration of heating at different temperatures.

FIG. 6 illustrates H₂O molar ratio with respect to Mg(PO₄) after 7 hours duration of heating at different temperatures.

FIG. 7 illustrates N:P molar ratio of synthetic struvite that undergone subsequent heating at 60.5° C. followed by rehydration

FIG. 8 illustrates the H₂O:P molar ratio of synthetic struvite that undergone subsequent heating at 60.5° C. followed by rehydration.

FIG. 9 illustrates the N—NH₄ molar ratio with respect to Mg(PO₄) of Lulu Island pellets (<1 mm) heated at three different relative humidity with increasing temperatures for different heating durations.

FIG. 10 illustrates the H₂O molar ratio with respect to Mg(PO₄) of Lulu Island pellets (<1 mm) heated at three different relative humidity with increasing temperatures for different heating durations.

FIG. 11 illustrates the N—NH₄ molar ratio with respect to Mg(PO₄) of Lulu Island pellets (<1 mm) heated at three different temperatures with increasing relative humidity for different heating durations.

FIG. 12 illustrates the H₂O molar ratio with respect to Mg(PO₄) of Lulu Island pellets (<1 mm) heated at three different temperatures with increasing relative humidity for different heating durations.

FIG. 13 illustrates the N—NH₄ molar ratio with respect to Mg(PO₄) of different sources and sizes of pellets heated at optimum conditions for different heating durations.

FIG. 14 illustrates H₂O molar ratio with respect to Mg(PO₄) of different sources and sizes of pellets heated at optimum conditions for different heating durations.

FIG. 15 illustrates the N—NH4 molar ratio with respect to Mg(PO₄) of Penticton B.C. pellets (<1 mm) heated at various combinations of temperature and relative humidity for different heating durations

FIG. 16 illustrates the H₂O molar ratio with respect to Mg(PO₄) of Penticton B.C. pellets (<1 mm) heated at various combinations of temperature and relative humidity for different heating durations.

It will be noted that throughout the appended drawings, like features are identified by like reference numerals.

### DETAILED DESCRIPTION

In accordance with the present disclosure, there is provided a process of releasing NH₃ from magnesium ammonium phosphate particles by heating the magnesium ammonium phosphate particles to a temperature of 50-120° C. in an atmosphere with a relative humidity of between 50 and 120%.

It is provided a process for removal and/or recovery of ammonium nitrogen from wastewater streams. The process includes: (1) formation of magnesium ammonium phosphate (MgNH₄PO₄.6H₂O, hereafter referred to as “struvite”) with simultaneous removal of ammonium nitrogen from the wastewater; (2) removal of struvite particles from the wastewater; and (3) thermal decomposition of the separated struvite particles in the presence of high humidity to evolve ammonia gas from it.

One aspect of the present disclosure is to return the residual solid product of thermal decomposition to the wastewater as the source of magnesium and orthophosphate ions to re-form struvite, and further remove ammonium nitrogen. The ammonia gas evolved from struvite may subsequently be captured for the purpose of recovering it as a product, or for preventing environmental pollution.

Struvite (MgNH₄PO₄.6H₂O), also known as magnesium ammonium phosphate (MAP), is a white crystalline substance comprised of magnesium, ammonium and phosphorus at equimolar concentrations. Struvite forms according to the following formula:

Mg²⁺+NH₄⁺+HnPO₄⁽ⁿ⁻³⁾+6H₂O↔MgNH₄PO₄.6H₂O+nH⁺(n=0-3; pH dependent)

One source of magnesium and orthophosphate ions to be added to a wastewater stream is a solid magnesium hydrogen phosphate, although a solution of the solid magnesium hydrogen phosphate, or a mixture thereof may also be used. The solution of the solid magnesium hydrogen phosphate can be obtained by dissolving it, entirely or partially, either in water/wastewater, or in acid, or in acidic solution, or in acidified water/wastewater. In this process, the solid magnesium hydrogen phosphate is obtained as the product of thermal decomposition of struvite particles formed in wastewater during ammonium nitrogen removal. This solid magnesium hydrogen phosphate has a varying composition with some, or no residual ammonium nitrogen and/or water of hydration present. It has a general chemical formula MgHₓ(NH₄)₍₁₋ₓ₎PO₄.yH₂O, where 0≤x≤1 and 0≤y≤7. This chemical formula does not limit the composition of the solid magnesium hydrogen phosphate, as it may contain other impurities incorporated from wastewater. One composition of the solid magnesium hydrogen phosphate is MgHPO₄.3H₂O, which is known under its mineral name newberyite. Accordingly, in an embodiment, the magnesium ammonium phosphate particles encompassed herein are substantially comprised of MgNH₄PO₄.6H₂O or struvite.

By using the solid product of struvite decomposition to reform struvite and simultaneously remove ammonium nitrogen from wastewater, the magnesium and orthophosphate ions are recycled, thereby eliminating the need for adding these ions externally. By forming newberyite, the magnesium and orthophosphate ions are recycled a number of times, before the loss of magnesium and orthophosphate occurs. Eventual magnesium and orthophosphate loss may need to be compensated by an external top-up addition of magnesium and orthophosphate in order to maintain required process efficiency.

Accordingly, as seen in FIG. 1, it is provided a process wherein magnesium ammonium phosphate particles (MAP) comprising MgNH₄PO₄.6H₂O or struvite are isolated 11 from a source of MAP, such as wastewater 10. The MAP particles/struvite are heated to decomposed 12 the struvite forming ammonia gas 14 and magnesium hydrogen phosphate 16. The ammonia gas can be processed into a fertilizer 18 for example. When the process described herein is in a continuous mode, magnesium hydrogen phosphate 16 can be remixed with wastewater to produce struvite and ammonia gas can be extracted in a continuous way.

A unique aspect of the process described herein is that the struvite thermal decomposition is performed in the atmosphere of humid, hot air or any other hot humid inert gas, or mixture thereof. The humid hot air/gas is created by either mixing dry air/gas with steam, or by dispersing liquid water in dry hot air/gas, or by evaporating moisture contained in bulk struvite particles, or by evolving the water of crystallization from struvite, or by any other means which would enable to achieve the relative humidity and temperature of the air/gas necessary to perform struvite thermal decomposition under preferred conditions. The use of humid air/gas prevents certain undesirable changes in struvite crystalline structure. As a result, ammonia gas can be completely removed from struvite at relatively lower temperatures in a shorter period of time than current technologies. In this invention, struvite thermal decomposition is performed at a temperature between 50-120° C., preferably between 75-85° C., and relative humidity between 50-120%, preferably between 80-100%, for the duration of time up to 24 h, preferably between 1-2 h. Contrary to known existing state-of-the-art processes which suggest performing struvite thermal decomposition at temperatures above 100-120° C. in dry air in order to release most of ammonia from struvite, or at temperatures below 100-120° C. without complete ammonia release from struvite, which reduces the overall efficiency of the nitrogen removal/recovery process, the process described herein is performed in an atmosphere of relative humidity.

The struvite thermal decomposition can be performed in any typical solid-gas process unit. It can be performed in a batch, semi-batch, or continuous mode. The unit may contain one bed of solid material, or more; the bed(s) can be fixed or moving, or alternatively fluidized. Encompassed, but not limited to, a fluidized bed unit can be used which is one of the most commonly used apparatus to perform struvite thermal decomposition, since it provides intensive mass and heat transfer. Also encompassed for example is the use of a drum dryer. The struvite thermal decomposition process can be performed on either struvite particles or on media/carrier particles coated with struvite. The struvite particles with linear dimensions between 0-5 mm, preferably between 0.5-1 mm, are used in the thermal decomposition process, if the media/carrier is not used. Struvite particles with increased surface area/porosity and low hardness are preferable over non-porous particles having high hardness.

After struvite thermal decomposition, the obtained solid product may be returned to the wastewater as the source of magnesium and orthophosphate ions for the purpose of reforming struvite, and further removing/recovering ammonium nitrogen. The reformation of struvite by adding the product of struvite thermal decomposition as a source of magnesium and orthophosphate ions back to wastewater can be performed in any typical solid-liquid process unit that is capable of forming struvite crystals. This may include, but not limited to, stirred tank unit, fluidized bed unit, or any combination thereof. An additional process unit may be used to pre-treat the struvite thermal decomposition product before reforming struvite in the reformation unit, for the purpose of maximizing process efficiency. A fluidized bed unit is a preferable type of apparatus to perform struvite reformation, since the desirable size of struvite particles can be easily and quickly obtained in it. Struvite can be reformed as struvite particles or as struvite coating on media/carrier. If the media/carrier is not used, struvite is formed as particles with linear dimensions between 0-5 mm, preferably between 0.5-1 mm. The molar ratio between the ammonium nitrogen in wastewater and the source of magnesium and orthophosphate ions to be added is maintained between 0.8-3, preferably between 1.05-1.55. Additional external source of either magnesium or orthophosphate ions can be added to the wastewater which initially contains magnesium and/or orthophosphate ions at a molar ratio of magnesium to orthophosphate other than 1, for the purpose of removal/recovery of either magnesium or orthophosphate ions in addition to ammonium nitrogen. Separation of the struvite particles from the wastewater may be carried out using any standard methods, including, but not limited to, gravity methods such as settling, sedimentation, filtration, fluidization, application of external forces, which includes, but is not limited to, vacuum/pressure filtration, separation in hydrocyclones, centrifugal separation. After separation, the struvite particles are thermally decomposed again in order to release ammonia.

The ammonia gas evolved from struvite during thermal decomposition may be used in many ways. For example, it may be captured and processed into a product, or separated from other inert gases and properly disposed of in order to prevent environmental pollution. The released ammonia gas can be either captured or separated from other gases by means of absorption or/and adsorption. The adsorbents and/or absorbents may include, but are not limited to: water; acids, either liquid or solid, or solutions thereof and their mixtures, or media/carrier coated/impregnated with acids; activated carbon and other solid sorbents; solutions of substances that bind ammonia into complexes. The ammonia gas absorbed/adsorbed in a liquid or on a solid can either be used directly as fertilizer, or be a precursor for further processing into fertilizers or other products. As an option, the ammonia gas evolved from struvite can be separated from other gases and/or concentrated by means of membrane separation, either in the liquid or gas phase, distillation, liquefying under high pressure and low temperature. It can also be captured, separated, and/or processed in any other way for the purpose of energy recovery and/or generation, where the energy can be generated by means of combustion of the recovered ammonia gas and using it as a fuel, or by means of using the recovered ammonia-water solutions as working fluids in the engines based on the Kalina cycle. At the same time, after ammonia separation from the humid hot air/gas, this air/gas can be reused in the process of struvite thermal decomposition in order to reduce operational costs of the process.

In a further embodiment, the magnesium hydrogen phosphate product is introduced to an aqueous solution containing ammonium and recycled to form magnesium ammonium phosphate. In one aspect, the aqueous solution containing ammonium is wastewater. In a further aspect, the wastewater is municipal wastewater, industrial wastewater or the wastewater produced from agriculture.

In yet another embodiment, it is provided herein a cyclical process wherein magnesium ammonium phosphate is heated in humid conditions to produce magnesium hydrogen phosphate and ammonia gas. The ammonia is collected and the magnesium hydrogen phosphate is converted back to magnesium ammonium phosphate by introducing it to an aqueous source of ammonium, such as wastewater. The magnesium ammonium phosphate is then collected and heated in a humid atmosphere thereby restarting the process.

It demonstrated herein that subsequent heating and rehydration increase ammonia gas evolution which normally cease when the struvite structure collapses due to excessive dehydration and formation of solid phase that entraps ammonia.

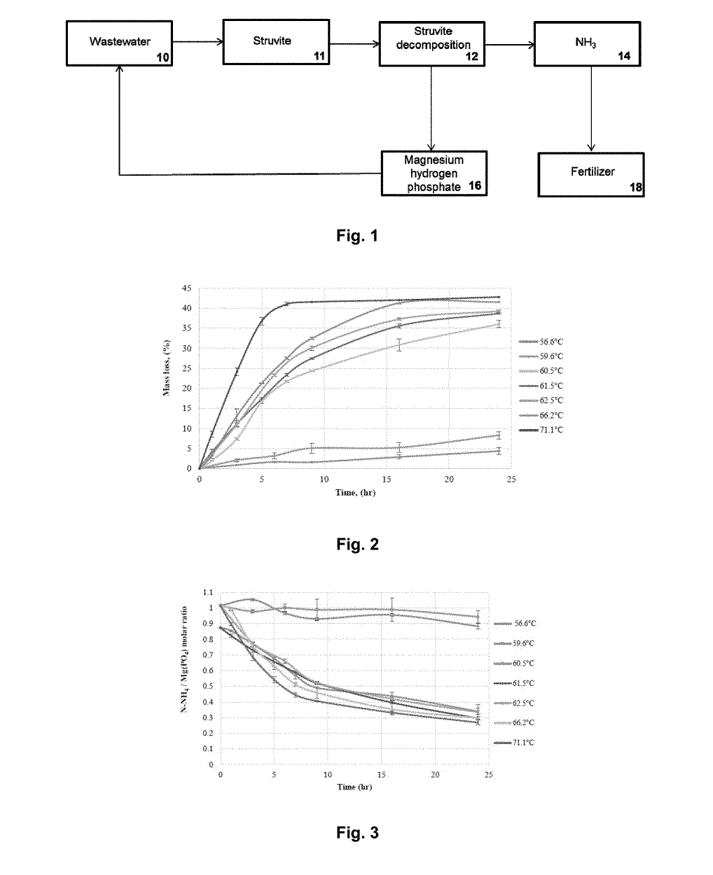

As shown herein, with an increase in temperature, the percent mass loss of struvite also increased (see FIG. 2). The mass loss percentage was not significant at temperatures below 60.5° C. Conversely, when the temperature was increased from 60.5° C. to 66.2° C., the mass loss percentage continued to increase with an increase in heating duration. However, the mass loss percentage became almost constant after heating for 7 hours at a temperature of 71.1° C. A substantial mass loss occurred between the temperatures of 59.6° C. and 60.5° C. and the corresponding mass losses at these two temperatures, after 24 hours, were around 9% and 36%, respectively. This indicates that, within the range of 60° C.±0.5° C., water vapor and gaseous ammonia evolution started and continued to increase further as the temperature increased. A mass loss of 42% occurred at a temperature of 71.1° C. after 7 hours, and remained constant for up to 24 hours. Accordingly, is it shown that higher temperatures lead to more rapid decomposition of struvite, due to enhanced loss of higher mass within a short period of time. Around 42% mass losses occurred at temperature of 80° C. after 24 hours of heating. The mass loss percentage increased about 10%, when the temperature was increased further from 80° C. to 200° C.

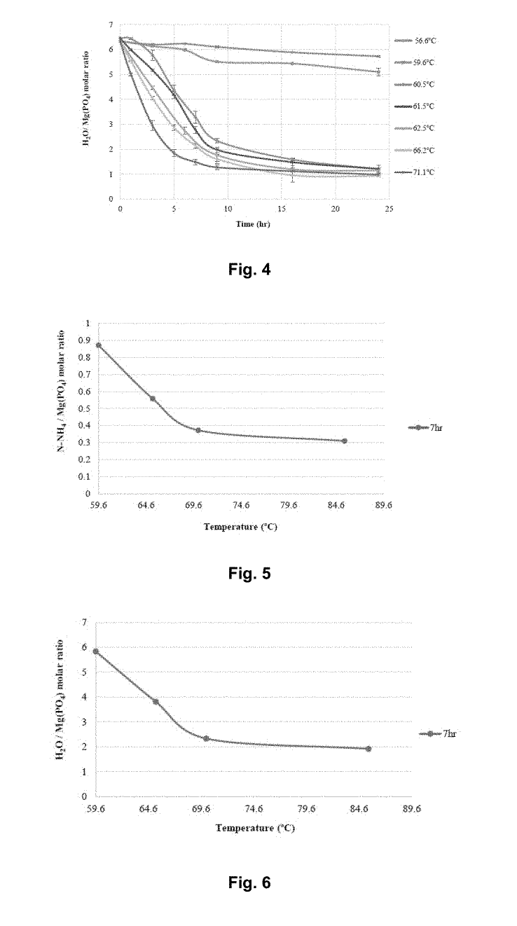

FIGS. 3 and 4 illustrate the average measured ammonia and water content remaining in the synthetic struvite when decomposed over time, at different temperatures. The extent of ammonia gas evolution depends on the duration of struvite heating and the temperature. Both magnesium and orthophosphate are non-volatile and cannot escape from the struvite upon heating. The results from the mass loss percentage measurements are consistent with the results of chemical analysis.

In FIGS. 3 and 4, the difference in ammonia and water content between initial struvite samples and the struvite samples decomposed at temperatures below 60.5° C. are not significant. This result is in agreement with the percent of mass loss seen in FIG. 2, wherein struvite samples were heated below 60.5° C. for 24 h duration. This confirms the thermal stability of struvite upon decomposition at temperatures below 60.5° C. At temperatures above 59.6° C., a sudden increase in ammonia and water evolution rate was observed with an increase in temperature and heating duration. Therefore, a significant increase in the mass loss percentage was observed at temperatures above 59.6° C.

Water molecules in struvite decreased from approximately 6 mole to approximately 1 mole when decomposed at temperatures higher than 59.6° C. after 24 hours, where the residual ammonium nitrogen in the decomposed solid phase was around 25-35% of struvite molar ratio (FIGS. 3 and 4).

The residual ammonia and water corresponding to the decomposed synthetic struvite, after 7 hours of heating at 59.6° C., were similar to those of the initial struvite composition (FIGS. 5 and 6). The higher temperatures cause rapid thermal decomposition of struvite, accompanied by a greater release of ammonia and water from the struvite solid phase.

One of the reasons behind a lack of ammonia removal normally observed from struvite structure can be explained by the formation of a layered structure. Based on chemical analysis and XRD results, the intensity of the layered structure peak increased with the decrease in ammonia and water content from the struvite structure, which also occurred in turn with the increase in heating duration. The residual solid phase obtained from struvite thermal decomposition at 61.5° C. contained a 2D amorphous layered structure along with a struvite structure, which is dependent on the heating duration. From XRD results, it was observed that the intensity of a layered structure peak became pronounced, while the majority of the crystalline struvite structure was transformed into an amorphous 2D layered structure. The layered structure peak appeared at low angles, after performing struvite thermal decomposition at 61.5° C. for 7 hours, after which the residual ammonia was around 67%. Any further increase in heating duration up to 24 hours at 61.5° C., caused a further decrease in 34% of the ammonia content. The enhanced formation of a layered structure lowered the ammonia and water evolution rate from the struvite structure. It was determined that the struvite structure completely transformed into a 2D amorphous structure layered structure, when the water content declined to 1.3 molecules after 24 hours of heating at 61.5° C. The complete transformation of struvite into an amorphous 2D layered structure inhibited the residual 33% ammonia evolution from the struvite structure. Therefore, there ammonia gas evolution was stopped when the structure completely transformed into a layered structure. The residual ammonia was entrapped inside the layers of magnesium and phosphate, and cannot be removed without collapsing the entire structure.

The water molecules in the struvite structure are responsible for hydrogen bonding. Any excessive removal of water can cause severe damage to the structure. Moreover, the magnesium atoms present in the struvite structure have a strong affinity towards oxygen, provided by water molecules from the crystallization before thermal decomposition.

It follows that it was investigated if the disappearance of a layered structure, upon rehydration, can increase the ammonia removal efficiency through subsequent heating and rehydration processes. Therefore, a synthetic struvite sample was subsequently heated and rehydrated three times, in order to observe any increase in ammonia removal efficiency.

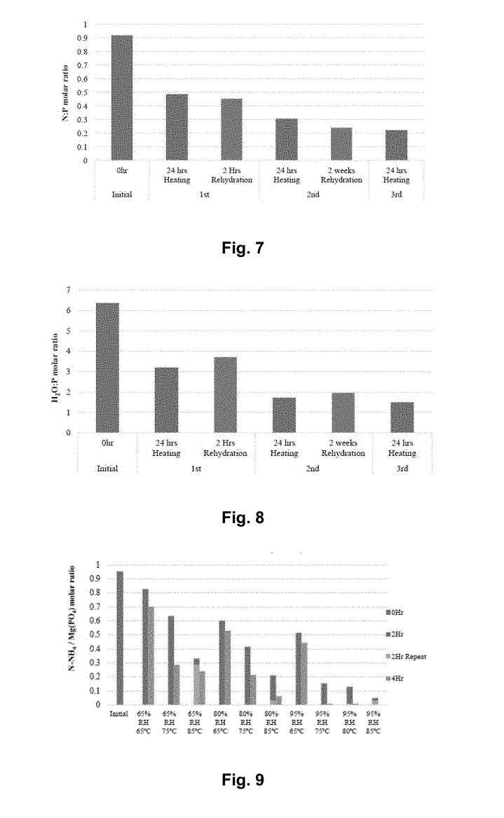

The N:P content in the raw struvite samples was around 0.9 which decreased to around 0.5 after 24 hours of heating at 60.5° C. There was a slim difference in the nitrogen content between the heated and rehydrated struvite samples (see FIGS. 7 and 8). The 2 hour rehydrated sample was heated a second time at the same temperature, for 24 hours, resulting in 20% more reduction of ammonia from the previously decomposed sample. There was 30% ammonia left in the struvite structure and the corresponding water content was around 1.8 molecules, which is similar to the struvite samples decomposed at 61.5° C. The nitrogen content decreased further to 20%, when the 2 week old rehydrated sample was heated for a 3rd time at 60.5° C., for 24 hours.

In order to accomplish complete ammonia removal from struvite, the layered structure formation needs to be prevented and the excess removal of water of crystallization from the struvite structure, causing dehydration, must also be prevented. The composition of the solid phase obtained from struvite thermal decomposition depends on the extent of ammonia and water removal from the struvite structure. Excessive water removal, without any ammonia evolution, leads to the formation of dittmarite, as per the following equation:

MgNH₄PO₄.6H₂O→MgNH₄PO₄.H₂O+5H₂O

However, the complete release of ammonia, with a controlled release of water, can lead to the formation of newberyite:

MgNH₄PO₄.6H₂O→MgHPO₄.3H₂O+NH₃+3H₂O

In order to prevent the formation of dittmarite type compounds and facilitate the formation of newberyite, the water vapor evolution or content needs to be minimized. This is achieved as described herein by providing high water vapour pressure during the struvite decomposition process.

It is thus provided that struvite decomposition under open atmosphere, with high water vapour pressure, leads to the formation of newberyite through the continuous release of ammonia from the structure, at high temperatures, in a fluidized bed reactor.

The initial ammonia and water contents in Lulu Island struvite pellets used herein were around 0.9 and 6.5 mole per 1 mole of Mg(PO₄), but depended on the surrounding atmospheric conditions such as humidity.

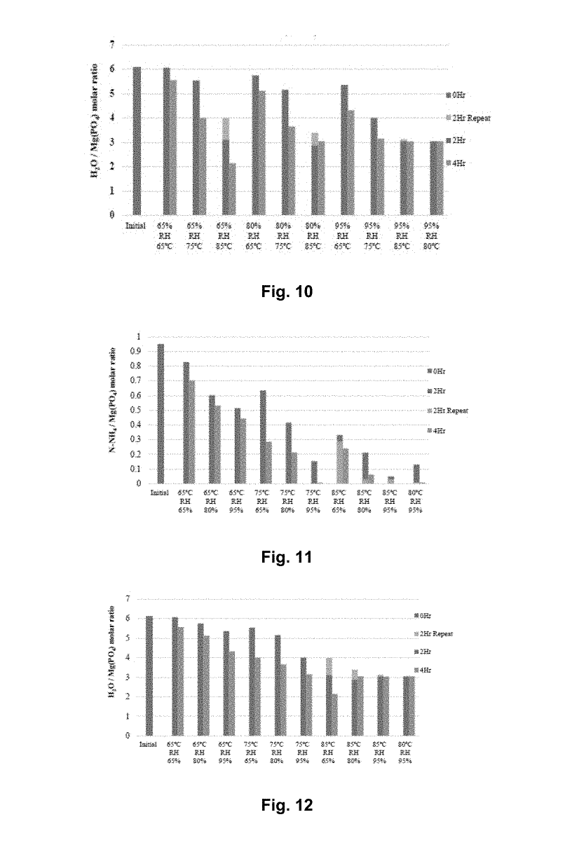

FIGS. 9 and 10 present the residual ammonia and water contents in the decomposed solid samples, when the Lulu Island pellets (<1 mm) were heated at different combinations of temperature and relative humidity (RH), for 2 and 4 hours. As intended herein, Lulu Island pellets are pellets retrieved from Lulu Island Wastewater Treatment Plant (Vancouver, Canada). In general, the higher the temperature, the greater the ammonia removal achieved at each humidity, and a significant amount of water evolved from the structure. Accordingly, good ammonia removal was achieved at 85° C., followed by 80° C., 75° C. and 65° C., for any particular humidity and duration of heating (see FIG. 9). For a particular humidity, the ammonia removal efficiency increased with increasing temperature. For example, at 95% RH and 2 hours of heating, the ammonia removal efficiency was 50%, 85%, 87% and 95% at temperatures 65° C., 75° C., 80° C. and 85° C., respectively.

However, struvite decomposition performed under higher temperatures, with lower humidity, reduced the ammonia removal efficiency. With 2 hours of heating at 85° C. under a “stable regime”, around 100% ammonia removal can be achieved at 95% RH, as opposed to 70% ammonia removed with 65% RH, after 2 hours of heating (FIG. 9). The residual water content was found to be 3 moles at 85° C., after 2 hours of heating with 95% RH.

Complete removal of ammonia could not be achieved at 65% RH, with 4 hours of heating, and a decomposition temperature of 85° C., due to the possibility of a layered structure being formed in the decomposed struvite product, due to excessive removal of water (4 moles in this case). As shown herein the higher the humidity, the more ammonia removal was achieved at any given temperature. The maximum ammonia removal efficiency was achieved at 95% RH, followed by 80% and 65% RH at any particular temperature and duration of heating. The ammonia removal efficiency was found to be greater at higher relative humidity, with a higher temperature.

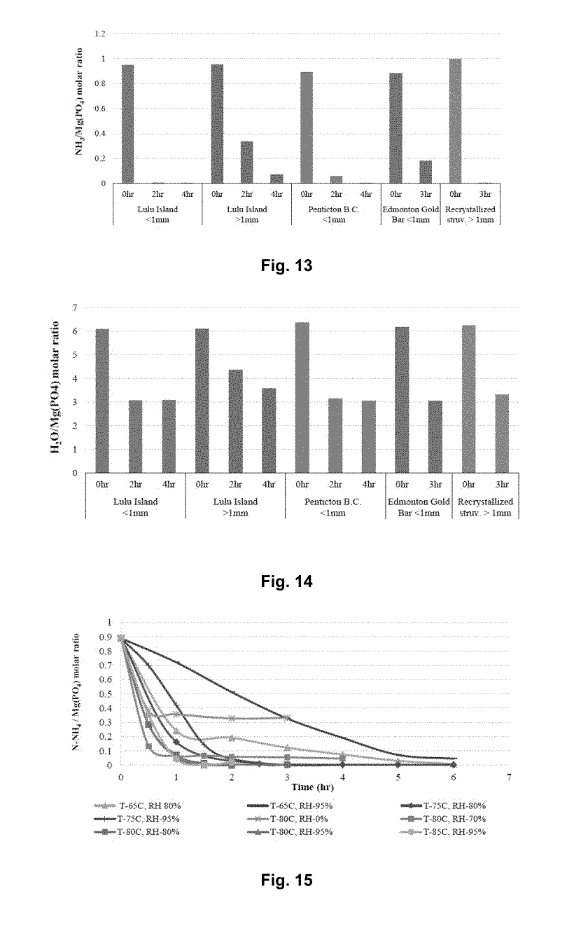

In FIGS. 11 and 12, the results obtained from heating Lulu Island struvite pellets at 85° C., with a relative humidity of 65%, 80% and 95% were obtained under an “unstable regime”. As seen in FIG. 11, more than 95% ammonia can be removed with 80% and 95% relative humidity with 2 hours of heating at 85° C. The residual water content was found to be 3.38 and 3.0 moles, respectively, for 80% and 95% RH with 85° C. (FIG. 12).

As shown herein, higher ammonia removal is achieved during heating of struvite and during retention of more water in the decomposed samples, preventing the structure from being compacted and eventually allowing more ammonia removal. Therefore, at higher temperatures and higher humidity, such as for example 85° C. or 80° C. with 95% RH, ammonia can be removed completely from Lulu Island struvite pellets.

Increases in temperature, up to 75° C., caused a significant increase in ammonia removal efficiency with the increase in heating duration from 2 to 4 hours. The prolonged 4 hours of heating at 95% RH provided a decomposed struvite product devoid of ammonia at 75° C., whereas around 45% ammonia was left in the decomposed struvite samples after heating at 65° C. The increase in relative humidity up to 95% at 85° C. resulted in about 97% ammonia removal, at 2 hours heating duration. Thus, it is shown that the heating of struvite pellets, at high relative humidity, with high temperature, can remove 100% ammonia, within 2 hours of heating. On the contrary, low temperatures, with high humidity conditions, will not favor complete ammonia removal, even with prolonged heating.

No dittmarite formation was found in the decomposed solid phase, after heating struvite at 85° C., with 65%, 80% and 95% RH. At 85° C. with 95% RH, the decomposed solid phase was entirely newberyite. Similar results were observed after heating at 80° C. with 95% RH.

In a preferred embodiment, the optimum operating conditions for struvite to newberyite transformation is 80° C. with 95% RH for 2 hours of heating.

Therefore, at lower humidity with a higher temperature, there is the possibility of a layered structure formation during heating, due to excessive dehydration, whereas higher humidity lowers the possibility of layered structure formation, and the preferred operating humidity range is suggested to be between 80% and 95% for complete transformation of struvite to newberyite.

In order to observe the ammonia removal efficiency from pellets of different size and source, Lulu Island pellets (smaller and larger than 1 mm), Penticton B.C. (pellets derived from Penticton Advanced Wastewater Treatment Plant in British Columbia, Canada) and Edmonton Gold Bar (pellets derived from the Gold Bar Wastewater Treatment Plant in Edmonton, Alberta, Canada) smaller than 1 mm, and recrystallized pellets larger than 1 mm, were heated at 80° C. and 95% relative humidity.

As described herein, ammonia will easily escape upon decomposition from softer and more porous the pellets. Smaller pellets are usually softer than larger pellets. As seen in FIGS. 13 and 14, the ammonia and water removal efficiency was found to be higher for smaller (<1 mm) Lulu Island pellets, compared to larger Lulu Island pellets (>1 mm), when heated under the same experimental conditions. The smaller Lulu Island pellets showed complete ammonia removal within 2 hours, whereas around 30% ammonia remained in the larger pellets. Complete ammonia removal could not be achieved from the larger pellets even after 4 hours.

Ammonia removal efficiency is thus related to the size of the struvite, as well as the hardness of the pellets. The larger pellets tested required a much higher gas flow velocity, compared to smaller pellets for proper fluidization. In addition, the transformation rate of struvite to newberyite, upon decomposition, is slower for larger pellets and is more susceptible to dittmarite formation with prolonged heating. On the other hand, the softer and smaller pellets are susceptible to dust formation during the experiment; this will reduce the amount of decomposed solid containing newberyite, after consuming a large amount of energy. Therefore, selection of size and hardness of the pellets based on the present disclosure allows choosing the most suitable pellets for complete conversion of struvite to newberyite, without forming dittmarite within the shortest period of heating.

As disclosed herein, under bench-scale conditions, the struvite pellets became fully transformed into newberyite, using hot air with steam. In is further disclosed that the provided process is industrially applicable. The reactor in the pilot-scale experiment was scaled up 7 folds, compared to the reactor in the bench-scale experiment. As provided, the optimum temperature and relative humidity identified from bench-scale experiments remove 100% ammonia from struvite pellets, when applied to the pilot-scale experiments. The process disclosed herein is energy efficient and economically feasible and uniform heating, uninterrupted steam supply, precise control of temperature, relative humidity and proper fluidization of struvite pellets facilitate NH₃ removal from the surface of struvite pellets.

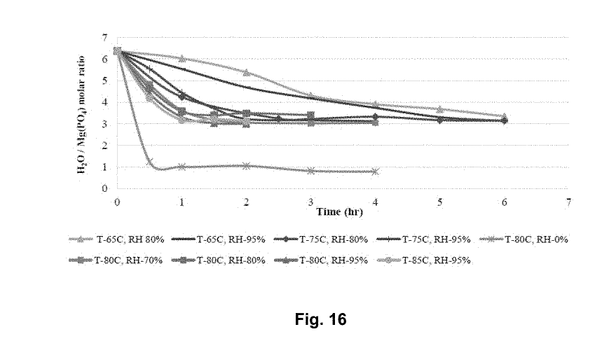

FIGS. 15 and 16 show residual ammonia and water content in the struvite decomposition product after heating at various combinations of temperature and relative humidity in pilot-scale experiments.

The solid product of struvite thermal decomposition described herein can also be used as a source of magnesium and orthophosphate ions to remove other chemical contaminants from various wastewater streams by means of forming other double salts of magnesium phosphate with it, beside struvite. Those chemical contaminants may include, but are not limited to, potassium ions K⁺, rubidium ions Rb⁺, cesium ions Cs⁺, thallium ions TI⁺. These double salts of magnesium phosphate can be valuable products and be used either directly as fertilizers or be precursors for further processing into various products.

In this application, the struvite thermal decomposition product such as magnesium hydrogen phosphate is added into wastewater containing one or more of the ammonium ions NH₄⁺, potassium ions K⁺, or any other of the aforementioned ions. This results in formation of sparingly soluble magnesium ammonium phosphate (MAP) MgNH₄PO₄.6H₂O, magnesium potassium phosphate (MKP) MgKPO₄.6H₂O, or any other magnesium phosphate and/or combinations thereof that incorporate one or more of the ions in its composition, such as, for example, Mg(NH₄)ₓ(K)_{y}PO₄.6H₂O, hereby removing the ions from the wastewater.

In another embodiment, the solid product of struvite thermal decomposition can be used as a precursor/reagent in producing magnesia phosphate cements. It can serve as a replacement for soluble phosphates, such as ammonium or potassium dihydrogen phosphate in the reaction with magnesia (magnesium oxide). The benefit of using the product of struvite thermal decomposition is significantly reduced amount of ammonia in the final product (magnesia-phosphate cement) and significantly reduced cost of such cement due to the use of phosphates recovered from wastewater instead of highly priced commodities.

It is disclosed herein that ammonia removal from struvite pellets is improved the higher the temperature and relative humidity, without forming any layered structure. Lower temperature and lower humidity also result in ammonia removal, but only with a longer duration of heating whereas higher temperature with lower humidity resulted in a layered structure formation, which reorganized and transformed into dittmarite, over time.

The complete transformation of struvite to newberyite preferably occurs at 80° C. and 85° C., with 95% RH. As demonstrate, herein, Penticton B.C. struvite pellets (0.5-1 mm) were completely transformed into newberyite, within 1.5 hours of heating at a temperature of 80±2° C. and 95±7% RH in pilot-scale experiments.

### Example I

### Preparation of Synthetic Struvite and Analysis

Synthetic struvite used for thermal decomposition was prepared by mixing equimolar quantities of magnesium chloride (MgCl₂.6H₂O) and ammonium di-hydrogen phosphate (ADP). Reagent grade 165.76 g MgCl₂.6H₂O and 93.73 g NH₄H₂PO₄ solutions were prepared in a 1 L stirred reactor using distilled water at 25° C. The pH of the solution was adjusted to a value of 8-9, using the slow addition of concentrated ammonium hydroxide (NH₄OH). The solution was agitated for 15 minutes, until the pH stabilized and then was retained in the reactor without any agitation, to precipitate struvite at a stoichiometric ratio of Mg:NH4:PO4 equal to 1:1:1. The reaction is as follow:

MgCl₂+NH₄H₂PO₄+6H₂O→MgNH₄PO₄.6H₂O+2HCl

The resulting suspension was filtered using Whatman 5 qualitative 12.5 cm diameter filters and a vacuum apparatus. The retained precipitates were washed thoroughly with distilled water and reagent alcohol. The synthetic struvite was allowed to dry in open air at room temperature overnight, to evaporate any residual water and alcohol. Following a similar approach, the synthetic struvite was prepared in the pilot plant in a 30-gallon tank in which the technical chemicals were added proportionally.

The purity of synthesized struvite was evaluated by chemical analysis and X-ray diffraction (XRD) analysis. A known amount of synthetic struvite 0.1 g) was dissolved in distilled water with the addition of concentrated hydrochloric acid (HCl). The solution was further diluted and analyzed for orthophosphate, ammonia and magnesium.

### Example II

### Bench-Scale Setup

The bench-scale experimental setup consisted of a fluidized-bed reactor (FBR) with jacket, heated water bath, diffuser, steamer, heater, heat tape with thermostat, flow meter, pressure gage, temperature, and humidity probe. The bench-scale, fluidized-bed reactor was cylindrical with an inside diameter of 1.5 cm (0.6 inch). The FBR reactor was surrounded by a jacket of 1.3 cm (0.5 inch) diameter. To prevent condensation inside the reactor, the jacket temperature was always maintained a few degrees higher than that inside the reactor. Temperature control was accomplished using a heated water bath (VWR Scientific-1130A) that provided continuous flow of water through the jacket. This reactor was connected to the heated water bath by (Fisher brand) 0.8 cm ( 5/16 inch) tubing both at the top and bottom, to maintain continuous hot water circulation. The reactor was connected at one corner atop the diffuser, a circular object 22.9 cm (9 inches) in diameter. The purpose of the diffuser is to mix the hot air and steam uniformly, prior to entering the reactor, and also to store inevitable condensed water. The condensed water was further collected from the bottom of the diffuser, by opening the lid (which remained closed during the experiment).

The diffuser had two separate injection ports for the hot air and steam. One injection port was connected to the heater through a heat tube, to supply continuous hot air, and another injection port was connected to the steamer. The floor steamer (Shark) used to supply steam had limited capacity and could only produce steam continuously for 1-1.5 hours; after that, it had to be refilled with 300-400 mL water during the experiment. To prevent heat loss, the diffuser was surrounded by heat tape with thermostat (OMEGALUX™ HTWC101-004). In order to monitor the pressure inside the diffuser, a pressure gage (Cole Parmer-model) was employed between the air valve and the heater. A flow meter was placed between the air inlet and the heater, to maintain proper fluidization of struvite pellets.

Steam was introduced into the diffuser after reaching the desired temperature inside the reactor, and a steam valve used to control the flow of steam. A humidity and temperature probe (Fisher Scientific™ Certified Traceable™ Digital Hygrometer/Thermometers: 11-661-7B) was mounted inside the diffuser, in order to monitor the relative humidity and temperature continuously during the process. Once the reactor was stabilized with respect to temperature and relative humidity, a suitable amount of struvite (3˜4 g) was added to the reactor from the top. The struvite was positioned over the mesh attached to the bottom of the reactor. The air flow was then adjusted by the air valve, to avoid slugging of the struvite bed. While refilling the steamer, condensed water was collected from the bottom of the diffuser and disposed of by a 5 cc syringe.

### Example III

### Pilot-Scale Setup

The continuous heating process was achieved throughout the pilot-scale experiments due to uninterrupted supply of air and steam. The entire heating process was performed in the fluidized bed reactor, similar to the bench-scale experiments, in order to increase the mass transfer and heat transfer which eventually provided the uniform decomposed products throughout the batches.

In the pilot-scale experiments, a continuous supply of hot air and steam as provided in order to transform all of the struvite pellets into newberyite, by maintaining high vapor pressure surrounding the struvite. The intensive mixing of struvite pellets with hot air and steam will provide uniform temperature and relative humidity throughout the decomposition process and thus, the final product would be uniform.

The pilot-scale reactor consisted of a fluidized bed reactor with jacket, diffuser, steam generator, heater for both jacket and reactor, temperature and process controller, flow meter both for jacket and reactor, temperature and humidity probe. The pilot-scale fluidized bed reactor (FBR) was cylindrical glass with an inner diameter of 41.275 mm (1.625) inch and a height of 91.44 cm (3 ft). The FBR is surrounded by a jacket of 76.2 mm (3 inch) diameter. In order to prevent condensation inside the reactor, the jacket temperature was always maintained higher than that inside the reactor. The temperature was raised inside the jacket using hot air, instead of the hot water that was used in the bench-scale experiments. The temperature in the jacket always needed to be maintained 7° C.−10° C. higher, compared to the reactor. Therefore, two separate heaters were used to provide continuous, hot air supply through the jacket and the reactor; these heaters were connected to the temperature and process controller, which was used to maintain the desired temperatures. Hot air entered into the jacket from the top of the reactor and exited from the bottom of the reactor. This prevented condensation from happening at the top of the reactor by maintaining a higher temperature throughout the jacket, compared to that inside the reactor. The reactor was sitting at the top of the aluminum diffuser, which was cylindrical and had a 4 inch diameter. The purpose of the diffuser was to supply the mixture of hot air and steam, prior to entering the reactor and also to store inevitable condensed water, which was drained from the bottom of the diffuser. The diffusor had two separate injection ports for the hot air and steam. The ports were installed on the opposite sides, with tangential injection of the gases. A steam generator (SUSSMAN MBA9 electric steam generator), with 0.0034 kg/s (27 lb/hr) steam capacity, was employed for continuous supply of steam inside the reactor. To prevent heat loss, the diffuser and the reactor were thermally insulated by glass cotton.

A humidity and temperature probe (Vaisala HUMICAP® HMI41 humidity indicator with HMP46 humidity and temperature probe) was inserted between the diffuser and the reactor, in order to monitor the relative humidity and temperature continuously during the process. The steam was introduced into the diffuser, after reaching the desired temperature inside the reactor and the flow was controlled using a steam valve. Once the reactor was stabilized with respect to temperature and relative humidity, a suitable amount (20-25 g) of struvite was added to the reactor from the top. The struvite sat over the mesh, which was attached between the bottom of the reactor and the top of the diffuser. The air flow was then adjusted with an air valve, to avoid slugging of the struvite bed. The air and steam valves needed to be adjusted precisely, to achieve the desired temperature and relative humidity throughout the process. The steam generator was refilled with the water automatically after a specified pressure drop (set at 40 psi in the pressure gage).

While the present disclosure has been described in connection with specific embodiments thereof, it will be understood that it is capable of further modifications and this application is intended to cover any variations, uses, or adaptations, including such departures from the present disclosure as come within known or customary practice within the art and as may be applied to the essential features hereinbefore set forth, and as follows in the scope of the appended claims.

What is claimed is:

1. A process of extracting ammonia gas from a source containing magnesium ammonium phosphate (MAP) particles comprising the steps of:
a) isolating MAP particles from the source;
b) heating MAP particles to a temperature of 50-120° C. in an atmosphere with a relative humidity between 50-120%, decomposing the MAP and producing a solid comprising magnesium hydrogen phosphate and ammonia gas; and
c) collecting the ammonia gas.

2. The process of claim 1, wherein the MAP particles are MgNH₄PO₄.6H₂O.

3. The process of claim 1 or 2, wherein the source of MAP particles is heated a temperature of 75-85° C.

4. The process of any one of claims 1-3, wherein the relative humidity is between 80-100%.

5. The process of any one of claims 1-4, wherein the MAP particles are heated and decomposed for up to 24 hours.

6. The process of any one of claims 1-5, wherein the MAP particles are heated and decomposed for 1-2 hours.

7. The process of any one of claims 1-6, wherein the source of MAP particles is wastewater.

8. The process of claim 7, wherein the wastewater is municipal wastewater, industrial wastewater or agriculture wastewater.

9. The process of any one of claims 1-8, further comprising the steps of:
d) mixing the solid comprising magnesium hydrogen phosphate with the source of MAP particles;
e) isolating the MAP particles;
f) heating the MAP particles mixed with to the solid decomposing the MAP and producing a new solid comprising magnesium hydrogen phosphate and ammonia gas; and
g) collecting the ammonia gas.

10. The process of any one of claims 1-9, wherein at least one of magnesium ions and orthophosphate ions are added to the source of MAP particles.

11. The process of any one of claims 1-10, wherein the MAP particles are isolated by settling, sedimentation, filtration or fluidization.

12. The process of claim 11, wherein the MAP particles are isolated by vacuum/pressure filtration, separation in hydrocyclones or centrifugal separation.

13. The process of any one of claims 1-12, wherein the collected ammonia gas is further processed as a fertilizer.

14. The process of any one of claims 1-13, wherein the MAP particles are heated and decomposed in a solid-gas process unit.

15. The process of claim 14, wherein the solid-gas process unit is a fluidized bed or a drum dryer.

16. The process of any one of claims 1-15, wherein humid hot air or gas is used to maintain the temperature and relative humidity, wherein the humid hot air or gas is created by mixing dry air or gas with steam or by dispersing liquid water in hot air or gas.

17. The process of any one of claims 1-16, wherein the process is performed in a batch mode, semi-batch mode or in a continuous mode.

18. The process of any one of claims 1-17, wherein the collected ammonia gas is captured by absorption or adsorption.

19. A process of extracting ammonia gas from a source containing magnesium ammonium phosphate (MAP) particles and extracting potassium ions from a source containing them comprising the steps of:
a) isolating MAP particles from the source;
b) heating MAP particles to a temperature of 50-120° C. in an atmosphere with a relative humidity between 50-120%, decomposing the MAP and producing a solid comprising magnesium hydrogen phosphate and ammonia gas;
c) collecting the ammonia gas;
d) mixing the solid comprising magnesium hydrogen phosphate with a source containing potassium ions or a mix of ammonium and potassium ions and producing a new solid comprising magnesium potassium phosphate (MKP) or a mix of MKP and MAP; and;
e) isolating the MKP or a mix MKP and MAP particles from the source.

20. The process of any one of claims 1-19, wherein the magnesium hydrogen phosphate is further incorporated into cement.
